(19) United States
(12) Patent Application Publication
(10) Pub. No.: US 2011/0012423 A1
(43) Pub. Date: Jan. 20, 2011

(54) MOTOR VEHICLE HAVING PLURAL BATTERY BANKS

(75) Inventors: Nicholas A. Gollmer, Hicksville, OH (US); Charles E. Howard, Silver Lake, IN (US)

Correspondence Address: International Truck Intellectual Property Company,, 4201 WINFIELD ROAD, WARRENVILLE, IL, 60555, US

(73) Assignee: International Truck Intellectual Property Company,LLC, Warrenville, IL (US)

(21) Appl. No.: 12/503,122

(22) Filed: Jul. 15, 2009

(51) Int. Cl. H02J 9/00

(52) U.S. Cl. 307/9.1; 320/123

(57) ABSTRACT

A DC-to-DC converter (32) is connected between two battery banks (12, 14) so that state-of-charge of the bank (12) is that is used to crank the engine of the vehicle is maintained without a direct connection to the alternator. Alternator current flows through one or more cables to the other bank (14) and that bank (14) keeps bank (12) charged via the converter (32).

### FIELD OF THE INVENTION

This invention relates generally to electrical systems of motor vehicles, especially large motor vehicles like highway trucks. More particularly, the invention relates to a vehicle electrical system that has plural battery banks.

### BACKGROUND OF THE INVENTION

Internal combustion engines that propel motor vehicles are typically started by turning an ignition switch to a start position that causes the engine to be cranked by an electric starter motor. When the engine has started, the switch is released from start position to assume a run position. In start position, electric current flows from a bank of D.C. storage batteries to the electric starter motor that cranks the engine through a set of gears. The amount of cranking current drawn from the battery bank is typically very large, necessitating the use of multiple individual batteries and connecting cables. With the engine running, an engine-driven alternator generates current for keeping the battery bank charged.

Drivers of line haul trucks that have sleeper cabs used by the drivers are subject to Federal Regulations concerning drive time vs. rest time. Extended rest times offer drivers opportunities for not merely rest but also personal relaxation in their trucks. Electrical devices and accessories, many of which would be considered common household accessories, are sometimes commercially available in 12 volt D.C. models that can be plugged into receptacles in a truck. Devices that use standard A.C. household voltage can operate in a truck that has an inverter for converting the D.C. voltage of the truck's electrical system into the required A.C. voltage. Computer, entertainment, and personal care devices and accessories are typical examples that are used in trucks.

The use of such devices and accessories combined with other loads on a truck's electrical system while a truck is parked, can cause the deep discharge and the high cycling that shorten battery life. Extreme discharge will prevent a battery bank from providing sufficient electric power to crank and start an engine.

Optional load shedding devices have been used to avoid extreme battery discharge, but they are considered by some to be less than fully effective in preventing “no start”.

The use of separate batteries in a motor vehicle electrical system is suggested by U.S. Pat. No. 6,229,279. That patent shows various circuits containing switches, both mechanical and electronic, for associating and disassociating the separate batteries with and from the vehicle electrical system.

Different types of lead-acid storage batteries are commercially available, and the selection of the battery type that is best for a particular application should be made on the basis of how the battery is to be used. One type of battery is sometimes referred to as a “starting” or “cranking” battery that is designed to deliver the bursts of electricity needed to crank an engine. Another is a “deep cycle” battery that is designed for greater long-term energy delivery, rather than the sudden intense bursts needed for engine cranking.

### SUMMARY OF THE INVENTION

One preferred embodiment of the present invention disclosed here employs two battery banks electrically isolated from each other except for a common connection to ground through the vehicle frame.

The first battery bank is intended for exclusive use to crank the engine at starting while also supplying voltage for operating an ECM (engine control module) and an automated transmission ECU (electric control unit) that are also needed for starting and driving the vehicle. Cranking batteries are preferred for the ones in this bank.

The second battery bank provides electrical power principally for the truck cab rather for engine cranking. Deep cycle batteries are preferred for the ones in this bank.

It is this second battery bank that is connected to the engine-driven alternator through a direct feed. The first battery bank is charged, not through a direct feed from the alternator, but rather through the direct alternator feed to the second battery bank and then a DC-to-DC converter that can boost a possibly lower voltage of the second battery bank to a desired voltage of the first, a voltage that is typically based on ambient temperature and will be greatest when ambient temperature is lowest. The DC-to-DC converter is outside the engine compartment and preferably located in proximity to at least one of the battery banks. While the battery banks may be in proximity to each other, such as in side-by-side battery trays, they may be in various locations that are more distant from each other. The DC-to-DC converter also provides temperature compensation for optimizing its output to the needs of the first battery bank during charging for keeping the first battery bank in a state of full charge.

In one disclosed embodiment, the converter is turned on and off with the vehicle's ignition switch so that when the ignition switch is ON, so is the converter, and when the ignition switch is OFF the converter is off too. The particular DC-to-DC converter described here can operate with as low as a 9.6 volt input to deliver an output current of 20 amps or more to the first battery bank. The DC-to-DC converter is uni-directional, meaning that as applied in the manner described here, it allows charge current to flow to, but not from, the first battery bank.

The “deep cycle” batteries of the second battery bank can better tolerate the high cab load cycling that is often typical in sleeper-equipped trucks. Because the first battery bank is essentially unaffected by the cycling to which the second battery bank often is, the useful life of the cranking batteries is significantly extended, perhaps two or even three times as long in a line haul truck that lacks separate battery banks. Some battery manufacturers say that AGM “deep cycle” batteries can have a life expectancy of two to three times that of flooded acid batteries. While the initial cost for a two-bank battery system might be higher than that of a single bank system, the cost differential can be economically justified by less vehicle downtime due to “no-starts”, by extension of battery life due to reduced cycling, and by the likelihood that the availability of at-home conveniences in a sleeper-equipped truck will aid a carrier in keeping experienced drivers.

Because of the isolation of the cranking batteries from cab loads, the engine should always crank when the ignition switch is turned on to start the engine as long as the DC-to-DC converter has been properly operating and the starter and the alternator have not failed.

Incorporation of an embodiment of the invention in a truck can be made without major changes as in the following example where a second battery box is added, preferably adjacent the existing one, for holding deep cycle batteries of a second battery bank that provides electrical power for the truck cab. A new cable directly connects the second battery bank to the alternator output of the existing charging circuit. The alternator can be a “remote sense” alternator. The DC-to-DC converter is connected between the two battery banks and a wire is run from it to the existing ignition circuit to allow the converter to be turned on and off from the ignition switch in the truck cab.

In another embodiment, the converter is turned on and off by the alternator output so that the converter is off when the alternator is not running, but is on when the alternator is running.

One general aspect of the invention relates to a motor vehicle comprising an engine that is started by cranking, a first charge storage medium, a second charge storage medium, and an electrical system that comprises an electric motor for cranking the engine. A direct feed connects the first charge storage medium to a solenoid that when operated closed by an ignition switch connects the direct feed through to the electric motor to crank the engine.

A charging system comprising an engine-driven alternator maintains state-of-charge of the two storage mediums by a direct feed from the alternator to the second charge storage medium.

A device is connected between the second storage medium and the first storage medium. The device allows the charging system to deliver charge to the first storage medium through the device while the ignition switch is in an ON position allowing the engine to run but prevents the first storage medium from delivering charge through the device when the ignition switch is in an OFF position that does not allow the engine to run.

Another general aspect of the invention relates to a motor vehicle comprising an engine that is started by cranking, a first charge storage medium, a second charge storage medium, and an electrical system that comprises an electric motor for cranking the engine. A direct feed connects the first charge storage medium to a solenoid that when operated closed by an ignition switch connects the direct feed through to the electric motor to crank the engine.

A charging system comprising an engine-driven alternator maintains state-of-charge of the two storage mediums while the engine is running by a direct feed from the alternator to the second charge storage medium.

A device is connected between the second storage medium and the first storage medium. The device allows the charging system to deliver charge to the first storage medium through the device while alternator is running but prevents the first storage medium from delivering charge through the device when alternator is not running due to the ignition switch being in an OFF position that does not allow the engine to run.

The foregoing, along with further aspects, features, and advantages of the invention, will be seen in the following disclosure of a presently preferred embodiment of the invention depicting the best mode contemplated at this time for carrying out the invention. The disclosure includes a drawing, briefly described as follows.

### BRIEF DESCRIPTION OF THE DRAWINGS

FIG. 1 is a schematic diagram of a first embodiment embodying principles of the present invention.

FIG. 1A shows modifications to portions of FIG. 1.

FIG. 2 is a schematic wiring diagram for the first embodiment.

FIG. 3 is a schematic diagram of a second embodiment embodying principles of the present invention.

### DESCRIPTION OF THE PREFERRED EMBODIMENT

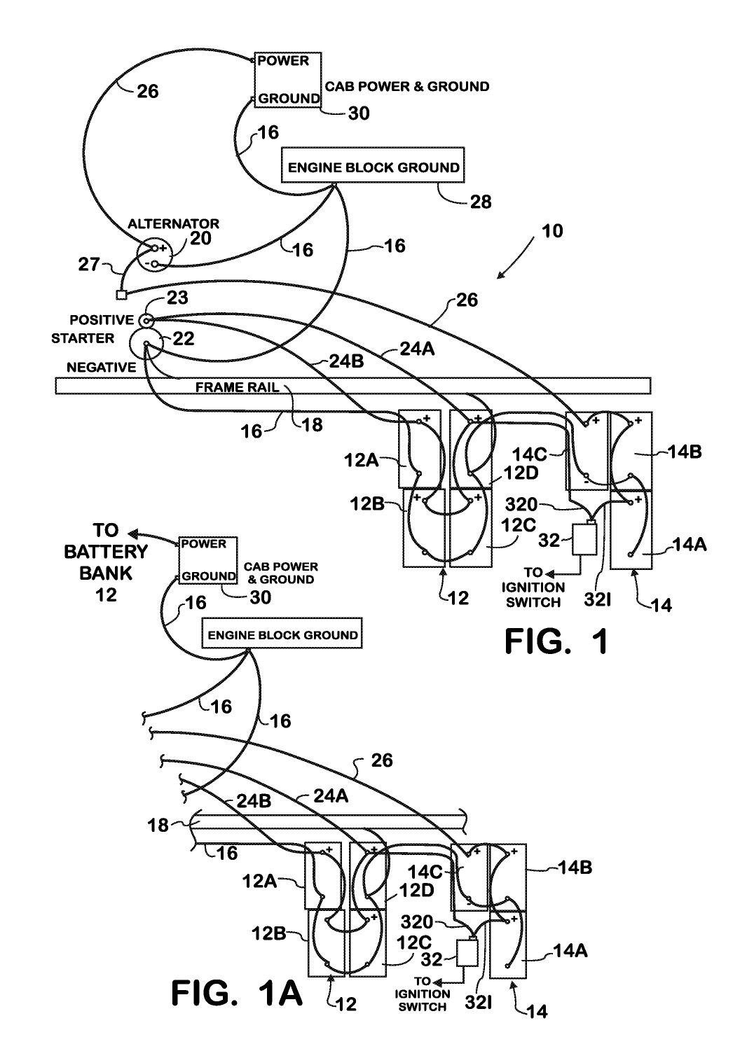

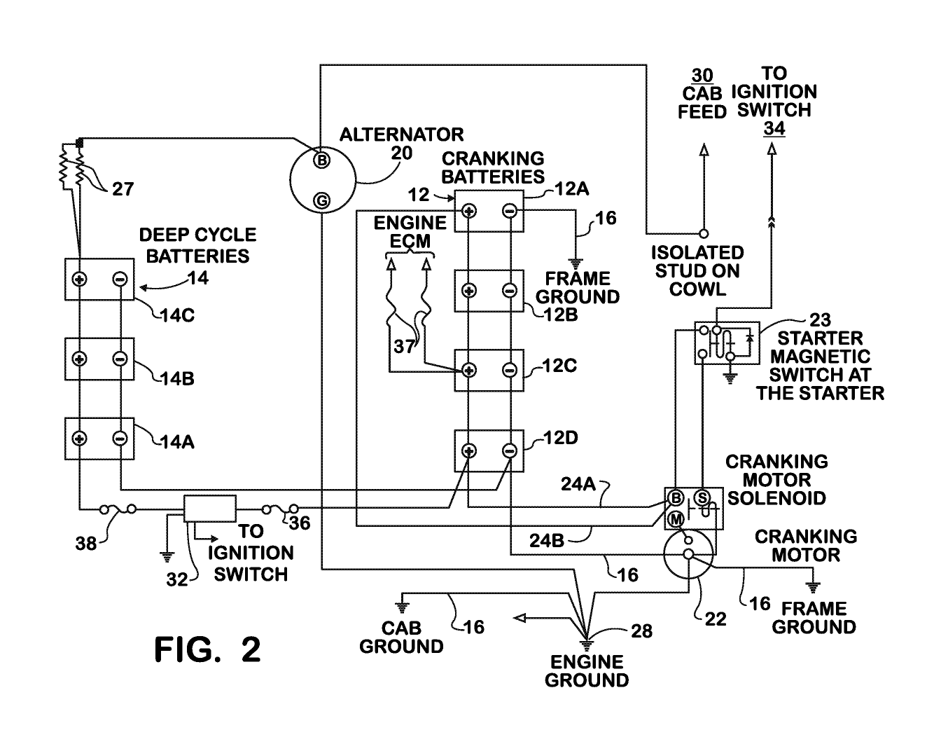

FIGS. 1 and 2 show a portion of a truck's electrical system 10 that has two battery banks 12, 14 in accordance with principles of the present invention. Battery bank 12 comprises four cranking type batteries 12A, 12B, 12C, and 12D having their negative terminal posts connected in common to ground 16 and supported on a battery tray that is hung from the side of a truck frame rail 18 that provides the ground. Battery bank 14 comprises three deep cycle type batteries 14A, 14B, and 14C also having their negative terminal posts connected in common by ground cables to ground (all grounded parts and ground cables being numbered 16). Those three batteries are supported on a second battery tray that is hung from the side of frame rail 18 next to the tray supporting battery bank 12. The particular number of individual batteries shown in the respective banks is merely representative, and as mentioned earlier, the battery trays need not be side-by-side.

Electrical system 10 is shown as a positive voltage system where the negative battery terminals are connected together and grounded as mentioned, the positive battery terminals of batteries 12A, 12B, 12C, and 12D are connected in common, and the positive battery terminals of batteries 14A, 14B, and 14C are connected in common. However, the positive terminals of the batteries in bank 12 are not directly connected in common with the positive terminals of the batteries in bank 14.

Electrical system 10 also comprises an engine-driven alternator 20 and an electric starter motor 22 for cranking the engine of the truck when the engine is to be started. A conventional mag switch 23 is associated with starter 22. When the engine runs, a belt drive (not shown) operates alternator 20 to supply needs of the electrical system including maintenance of battery bank charge.

The positive terminals of the batteries of bank 12 are directly connected to a terminal of starter motor 22 by two parallel cables 24A, 24B with this particular number of cables also being merely representative. The positive terminals of the batteries of bank 14 are directly connected by a positive cable 26 through a pair of parallel fusible links 27 to the positive output terminal of alternator 20, with the use of a single cable and two fusible links also being merely representative. The positive potential of cable 26 is extended to the cab portion 30 of the electrical system.

Ground cables ground a ground terminal of alternator 20, a ground terminal of starter motor 22, the engine block 28, and cab ground to frame rail 18.

A DC-to-DC converter 32 that is on the tray containing battery bank 14 couples battery bank 14 to battery bank 12. A ground terminal of converter 32 is grounded to the frame rail. An input feed 32I that contains a fuse 38 connects the positive terminals of the batteries of bank 14 to a positive input terminal of converter 32. An output feed 32O that contains a fuse 36 connects a positive output terminal of the converter to the positive terminals of the batteries of bank 12.

FIG. 2 shows a feed from an ignition switch 34 in the truck cab to mag switch 23. When the ignition switch is turned to start position, mag switch 23 operates, and in turn operates a solenoid in motor 22 that operates the motor to crank the engine using battery bank 12. FIG. 2 also shows a feed that runs to the converter from the ignition switch for turning the converter on and off from the ignition switch in the truck cab when the ignition switch is turned on and off. With the engine running after having been started, the ignition switch remains on, causing converter 32 to remain on as long as the ignition switch remains on. Turning the ignition switch off, turns the converter off

Battery bank 12 is charged, not through a direct feed from alternator 20, but rather by converter 32 when the converter is on. The converter is uni-directional, meaning that it allows charge current to flow from battery bank 14 to battery bank 12, but not vice versa.

From the foregoing description and the drawings, it can be appreciated that battery bank 14 serves two functions: 1) to keep battery bank 12 charged, and 2) to provide voltage for the cab portion of the electrical system. It can be further appreciated that the only loads that are imposed on battery bank 12 are those of motor 22 when the engine is being cranked and those of the engine control module (ECM) and an automated transmission electric control unit (not shown in the drawings) when the ignition switch is in either on or crank position. The ECM is fed through separate fuses 37 as shown in FIG. 2.

After it has cranked the engine, battery bank 12 is kept charged while the engine continues to run. Once the ignition switch is turned off, charging stops, but while the ignition switch is off, there is no load on battery bank 12.

Converter 32 preferably contains a thermistor that controls the charging of battery bank 12 so as to keep it charged to a desired voltage regardless of ambient temperature. In this way the converter can boost a possibly lower voltage of battery bank 14 to a desired higher voltage for battery bank 12. The particular DC-to-DC converter 32 described here can operate with as low as a 9.6 volt input to deliver a 20 amp or greater output current to battery bank 12.

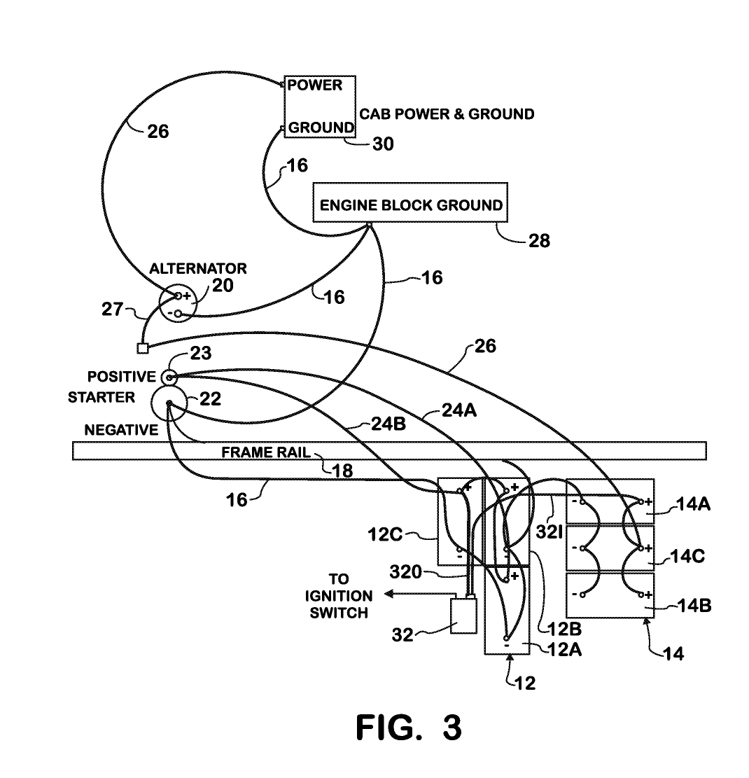

FIG. 1A shows the following modifications, without repeating the entire FIG. 1. The first modification involves connecting the cab portion of the electrical system directly to battery bank 12 instead of to alternator 20. The second modification involves connecting converter 32 to the alternator output instead of to the ignition switch ON terminal. This provides for the converter to be turned on and off by the alternator output so that the converter is off when the alternator is not running, but is on when the alternator is running It is to be understood that there modifications apply to FIGS. 2 and 3 as well.

FIG. 3 shows a second embodiment where the same reference numerals from FIGS. 1 and 2 are used identify the same components. The second embodiment differs from the first in that battery bank 12 contains only three batteries and converter 32 is on the tray of battery bank 12.

Although not shown in the drawings, a charge storage medium such as an ultra-capacitor could be substituted for the cranking batteries.

While a presently preferred embodiment of the invention has been illustrated and described, it should be appreciated that principles of the invention are applicable to all embodiments that fall within the scope of the following claims.

What is claimed is:

1. A motor vehicle comprising:
an engine that is started by cranking;
a first charge storage medium;
a second charge storage medium;
an electrical system that comprises an electric motor for cranking the engine, a direct feed from the first charge storage medium to a solenoid that when operated closed by an ignition switch connects the direct feed through to the electric motor to crank the engine;
a charging system comprising an engine-driven alternator for maintaining state-of-charge of the two storage mediums;
a direct feed from the alternator to the second charge storage medium; and
a device that is connected between the second storage medium and the first storage medium and that allows the charging system to deliver charge to the first storage medium through the device while the ignition switch is in an ON position allowing the engine to run but prevents the first storage medium from delivering charge through the device when the ignition switch is in an OFF position that does not allow the engine to run.

2. A motor vehicle as set forth in claim 1 in which at least one of the first and second charge storage mediums comprises a battery bank.

3. A motor vehicle as set forth in claim 2 in which the first and second charge storage mediums comprise respective battery banks.

4. A motor vehicle as set forth in claim 1 in which the device comprises a DC-to-DC converter.

5. A motor vehicle as set forth in claim 1 in which a feed from the ignition switch to the DC-to-DC converter turns the DC-to-DC converter on when the ignition switch is in ON position and turns the DC-to-DC converter off when the ignition switch is in OFF position.

6. A motor vehicle as set forth in claim 1 in which the first charge storage medium comprises a battery bank whose stored energy is used exclusively for cranking the engine.

7. A motor vehicle comprising:
an engine that is started by cranking;
a first charge storage medium;
a second charge storage medium;
an electrical system that comprises an electric motor for cranking the engine, a direct feed from the first charge storage medium to a solenoid that when operated closed by an ignition switch connects the direct feed through to the electric motor to crank the engine;
a charging system comprising an engine-driven alternator for maintaining state-of-charge of the two storage mediums while the engine is running;
a direct feed from the alternator to the second charge storage medium; and
a device that is connected between the second storage medium and the first storage medium and that allows the charging system to deliver charge to the first storage medium through the device while alternator is running but prevents the first storage medium from delivering charge through the device when the alternator is not running due to the ignition switch being in an OFF position that does not allow the engine to run.

8. A motor vehicle as set forth in claim 7 in which at least one of the first and second charge storage mediums comprises a battery bank.

9. A motor vehicle as set forth in claim 8 in which the first and second charge storage mediums comprise respective battery banks.

10. A motor vehicle as set forth in claim 7 in which the device comprises a DC-to-DC converter.

11. A motor vehicle as set forth in claim 7 in which a feed from the alternator to the DC-to-DC converter turns the DC-to-DC converter on when the alternator is being driven by the engine and turns the DC-to-DC converter off when alternator is not being driven by the engine.

12. A motor vehicle as set forth in claim 7 in which the first charge storage medium comprises a battery bank whose stored energy is used exclusively for cranking the engine.
